(19) United States
(12) Patent Application Publication
(10) Pub. No.: US 2013/0236117 A1
(43) Pub. Date: Sep. 12, 2013

(54) APPARATUS AND METHOD FOR PROVIDING BLURRED IMAGE

(71) Applicant: SAMSUNG ELECTRONICS CO., LTD., Gyeonggi-do (KR)

(72) Inventors: Dong-Hyuk LEE, Seoul (KR); Do-Hyeon Kim, Gyeonggi-do (KR); Hee-Bum Ahn, Seoul (KR); Dong-Chang Lee, Daegu (KR); Won-Suk Chang, Gyeonggi-do (KR)

(73) Assignee: Samsung Electronics Co., Ltd., Gyeonggi-do (KR)

(21) Appl. No.: 13/790,584

(22) Filed: Mar. 8, 2013

(30) Foreign Application Priority Data
Mar. 9, 2012 (KR) 10-2012-0024675

(51) Int. Cl. G06T 5/00

(52) U.S. Cl. CPC G06T 5/002
USPC 382/264

(57) ABSTRACT

A method of providing a blurred image includes receiving a target image to which a blur effect is to be applied; receiving blur effect information for generating the blur effect in the target image; calculating a sum image for respective pixels of the target image; applying a mean filter to the target image by using the sum image based on the blur effect information; and providing a blurred image formed by applying the mean filter.

### PRIORITY

This application claims priority under 35 U.S.C. §119(a) to Korean Application Serial No. 10-2012-0024675, which was filed in the Korean Intellectual Property Office on Mar. 9, 2012, the entire content of which is incorporated herein by reference.

### BACKGROUND OF THE INVENTION

1. Field of the Invention

The present invention generally relates to an apparatus and a method for providing a blurred image.

2. Description of the Related Art

A smart phone or tablet PC now typically includes a camera module, and accordingly, a user may take photographs by using the smart phone or the tablet PC. An editing application or program for giving a particular effect to the photographed image is also being actively distributed. Compared with a conventional mobile communication terminal, the smart phone or tablet PC has a high capability Central Processing Unit (CPU), and accordingly, can perform an operation of giving various effects to the photographed image.

Meanwhile, among the various effects, an image blur effect intentionally degrades definition in a designated part of effect generation and allows the user to recognize the image with a blurred effect. The blur effect may be created by applying a representative filter, such as a mean filter and a Gaussian filter. However, when one of the two filters is applied, since the filter is applied to the plurality of pixels included in one image, calculation quantities rapidly increase. Particularly, for a relatively greater blurry visual effect, a relatively large size filter should be applied.

More specifically, in order to apply the mean filter, a sum of respective pixels within the filter is required, and calculation quantities rapidly increase when the relatively large size filter is applied. Even though the smart phone or the tablet PC has a high capability central processing unit in comparison with a conventional mobile communication terminal, its calculation capability is not as good as that of a general computer. Accordingly, when the blur operation for the relatively greater blurry visual effect is performed, the effect cannot be identified in real time.

### SUMMARY OF THE INVENTION

The present invention has been made to address the above mentioned problems and disadvantages, and provides an apparatus and a method for providing a blurred image which can form a sum image and reduce calculation quantities by using the formed combined image.

In accordance with an aspect of the present invention, a method of providing a blurred image is provided. The method includes receiving a target image to which a blur effect is to be applied; receiving blur effect information for generating the blur effect in the target image; calculating a sum image for respective pixels of the target image; applying a mean filter to the target image by using the sum image based on the blur effect information; and providing a blurred image formed by applying the mean filter.

In accordance with another aspect of the present invention, an apparatus for providing a blurred image is provided. The apparatus includes an input unit for receiving blur effect information for generating a blur effect in a target image to which the blur effect is to be applied; a controller for calculating a sum image for respective pixels of the target image, and applying a mean filter to the target image by using the sum image based on the blur effect information; and a display unit for providing a blurred image formed by applying the mean filter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects, features and advantages of certain embodiments of the present invention will be more apparent from the following description taken in conjunction with the accompanying drawings, in which:

FIG. 1 is a block diagram of a blurred image providing apparatus according to an embodiment of the present invention;

FIG. 2 is a flowchart illustrating a blurred image providing method according to an embodiment of the present invention;

FIGS. 3A to 3J are conceptual diagrams describing a blurred image generating process according to an embodiment of the present invention;

FIG. 4 is a block diagram illustrating a blurred image providing apparatus according to another embodiment of the present invention;

FIG. 5A is an illustrative diagram of a target image according to an embodiment of the present invention;

FIG. 5B is an illustrative diagram of a blurred image generated by applying a blur effect to the target image of FIG. 5A;

FIGS. 6A and 6B are conceptual diagrams for describing examples of blur effect information according to various embodiments of the present invention;

FIGS. 7A to 7D are conceptual diagrams of a user interface according to the present invention; and

FIGS. 8A to 8C are illustrative diagrams of blurred images based on various resolutions according to various embodiments of the present invention.

### DETAILED DESCRIPTION OF EMBODIMENTS OF THE PRESENT INVENTION

Hereinafter, various embodiments of the present invention will be described in detail with reference to the accompanying drawings. The same elements will be designated by the same reference numerals although they are shown in different drawings. Further, in the following description of the present invention, a detailed description of known functions and configurations incorporated herein will be omitted when it may make the subject matter of the present invention unclear.

According to various embodiments of the present invention, it is possible to reduce calculation quantities required for providing a blurred image and thus provide a blur effect in real time in a smart phone or a table PC.

Further, it is possible to gradually give the blur effect and thus allow a user to recognize the dynamic blur effect. In addition, a more natural blur effect can be created with optimized calculation quantities through a technique of applying a Gaussian filter to an edge part of a blur target image.

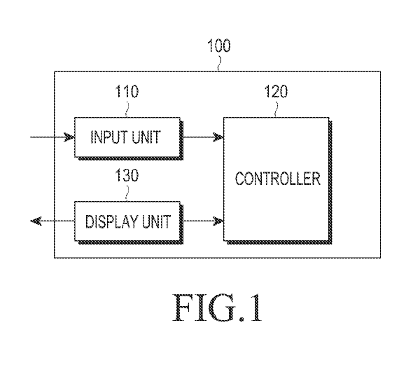

FIG. 1 is a block diagram of a blurred image providing apparatus according to an embodiment of the present invention.

As illustrated in FIG. 1, a blurred image providing apparatus 100 includes an input unit 110, a controller 120, and a display unit 130. For example, the blurred image providing apparatus 100 may be implemented by a smart phone or a tablet PC including the controller 120 having a predetermined ability. The blurred image providing apparatus 100 may be implemented in a form changeable easily by those skilled in the art, and the form does not have a particular limitation.

The input unit 110 receives an input of blur effect information containing information on a blur effect. Here, the blur effect information contains at least one piece of information on an area to which the blur effect is given in a blur target image and information on a blur effect degree. The input unit 110 may be implemented in a form of a key pad including a direction selection key or a determination key through which a user may designate an area to which the blur effect is given or designate the blur effect degree. The user inputs the blur effect while visually recognizing the blur target image displayed on the display unit 130.

Alternatively, the input unit 110 may be physically connected to the display unit 130 to be implemented in a form of a touch screen. When the input unit 110 is implemented by the touch screen, and the user inputs blur effect information, the user may directly designate a particular area on the target image. More specifically, the user may designate an area to which the blur effect is given, by using a finger, an Electromagnetic resonance (EMR) pen or the like.

The input unit 110 outputs blur effect information to the controller 120.

The controller 120 controls a general operation of the blurred image providing apparatus 100, and may be implemented by, for example, a Central Processing Unit (CPU), a Graphic Processing unit (GPU), a mini computer or the like. The controller 120 gives the blur effect to the target image based on the input blur effect information.

More specifically, the controller 120 first configures a sum image for respective pixels of the target image. Here, the sum image may be an image which determines a particular pixel value by cumulatively adding the pixels of the target image. For example, a pixel value of (i,j) of the sum image may be determined as a sum of a pixel value of (1,1), a pixel value of (1,2), a pixel value of (1,3), . . . , a pixel value of (1,j), a pixel value of (2,1), a pixel value of (2,2), a pixel value of (2,3), . . . , a pixel value of (2,j), . . . , a pixel value of (i,1), a pixel value of (i,2), . . . , a pixel value of (i,j−1), and a pixel value of (i,j) of the target image having an m×n size. That is expressed as Equation (1) below.

$$s ( i , j ) = {\sum }_{b = 1}^{j} {\sum }_{a = 1}^{i} f ( a , b ) \qquad ( 1 )$$

In Equation (1), s(i,j) denotes a (i,j)^{th} pixel value of the sum image, and f(a,b) denotes an (a,b)^{th} pixel value of each target image.

The controller 120 may apply a mean filter to the target image. Here, the mean filter is a filter of which respective elements have the same value, for example, a value of 1. For example, when the (i,j) pixel value of the target image is f(i,j), a pixel value after the application of the mean filter may be indicated as f(i,j). Here, it is assumed that a size of the mean filter is p×p. p is an odd number.

The f(i,j) pixel value may be an arithmetic mean of all pixels within the mean filter based on (i,j). That is, f(i,j) may be expressed as Equation (2) below.

$${f}^{′} ( i , j ) = \frac{{\sum }_{b = i - \frac{p - 1}{2}}^{i + \frac{p - 1}{2}} {\sum }_{a = i - \frac{p - 1}{2}}^{i + \frac{p - 1}{2}} f ( a , b )}{{p}^{2}} \qquad ( 2 )$$

Meanwhile, in a process of adding up the pixel values within the mean filter, the controller 120 may reduce calculation quantities required during the adding up process by using the sum image. The controller 120 may not perform all calculations in a numerator part in Equation (2), and a calculation result of the numerator part may be achieved by using a sum image value as defined in Equation (3).

$${\sum }_{b = i - \frac{p - 1}{2}}^{i + \frac{p - 1}{2}} {\sum }_{a = i - \frac{p - 1}{2}}^{i + \frac{p - 1}{2}} f ( a , b ) = s ( i , j ) + s ( i - p , j - p ) - s ( i - p , j ) - s ( i , j - p ) \qquad ( 3 )$$

Through Equation (3), the controller 120 may significantly reduce calculation quantities when the mean filter is applied.

That is, the controller 120 may use Equation (4) for the application of the mean filter.

$${f}^{′} ( i , j ) = \frac{s ( i , j ) + s ( i - p , j - p ) - s ( i - p , j ) - s ( i , j - p )}{{p}^{2}} \qquad ( 4 )$$

The controller 120 forms a blurred image generated by applying the mean filter, that is, a blurred image where the (i,j)^{th} pixel value has a value of f(i,j) by Equation (2).

The controller 120 applies the mean filter based on blur effect information input from the input unit 110. For example, the controller 120 may apply a relatively large sized mean filter to a point having a relatively large blur effect degree. Further, the controller 120 may apply a relatively small sized mean filter to a point having a relatively small blur effect degree. In addition, for example, when the blur effect information corresponds to information where the blur effect degree gradually increases from a first point to a second point of the target image, the mean filter having a size which gradually increases from the first point to the second point may be applied. This will be described below in more detail with reference to embodiments of the present invention.

The controller 120 controls the display unit 130 to display the configured blurred image.

The display unit 130 displays the target image. Alternatively, the display unit 130 may display the configured blurred image based on the blur effect information. The display unit 130 may be implemented by an LCD module or the like. Also, the display unit 130 may be implemented in a form of a touch screen physically connected to the input unit 110. Meanwhile, it may be understood by those skilled in the art that the display unit 130 may be any means which can display a predetermined image.

Although not illustrated, the blurred image providing apparatus 100 may further include a means for receiving the target image to which the blur effect is given. The means may be implemented by an interface capable of receiving a pre-photographed image, for example, a USB port or the like. Alternatively, the means may be implemented by a photographing means capable of photographing a foreground, not the means for simply receiving the photographed image, for example, a camera module or the like. When the input unit 110 is implemented in a form of the photographing means, the input unit 110 may be implemented by a Charge-Coupled Device (CCD) photographing element, a Complementary Metal Oxide Semiconductor (CMOS) photographing element, or the like.

According to the above embodiment, an effect of significantly reducing the calculation quantities required for applying the mean filter may be created. Accordingly, it is possible to provide the blurred image in real time in accordance with blur effect information input by the user.

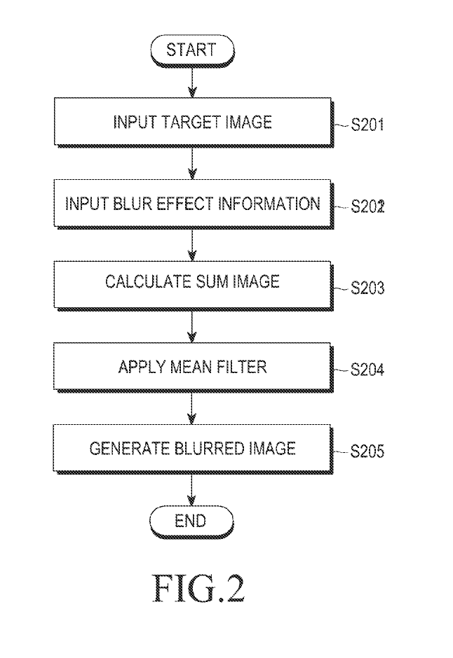

FIG. 2 is a flowchart of a blurred image providing method according to an embodiment of the present invention.

The blurred image providing apparatus receives a target image in step S201. Here, the target image may include a preset pixel size, for example, an m X n size pixel. The blurred image providing apparatus displays the received target image.

The blurred image providing apparatus receives blur effect information from the user in step S202. For example, the blur effect information may contain one or both of a blur effect point and a blur effect degree. Alternatively, the blur effect information may designate a blur effect start point and end point. In this case, the blur effect information may be information where the blur effect gradually increases from the start point to the end point.

The blurred image providing apparatus calculates a sum image by using the target image in step S203. Here, the sum image may be an image which determines a particular pixel value by cumulatively adding respective pixels of the target image. For example, the sum image may be determined by Equation (1).

The blurred image providing apparatus applies the mean filter to the target image in step S204. Meanwhile, in a configuration of applying the mean filter, the blurred image providing apparatus may use the sum image. More specifically, the blurred image providing apparatus reduces calculation quantities required for adding up the pixel values within the mean filter by using the sum image.

The blurred image providing apparatus generates the blurred image based on an application result of the mean filter and displays the generated blurred image in step S205.

According to the above embodiment, an effect of significantly reducing calculation quantities required for applying the mean filter may be created. Accordingly, it is possible to provide the blurred image in real time in accordance with a blur effect information input by the user.

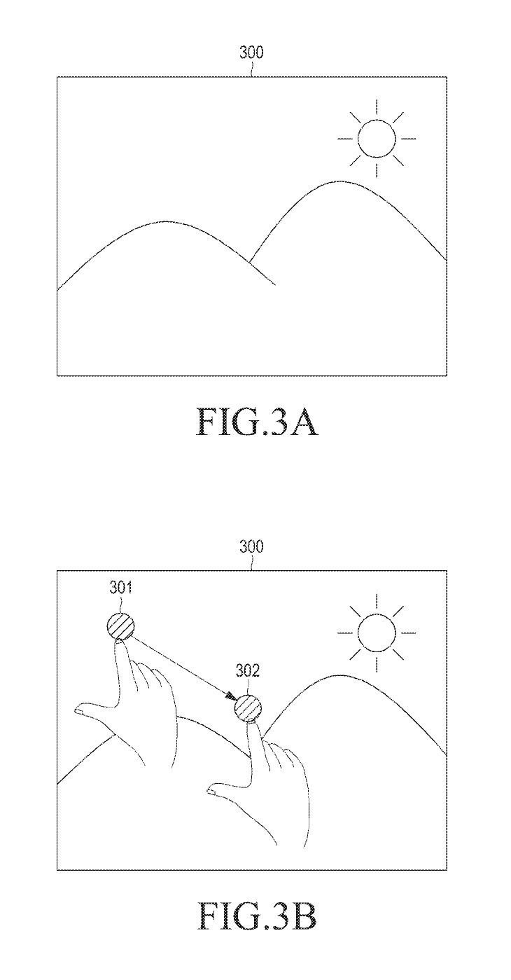

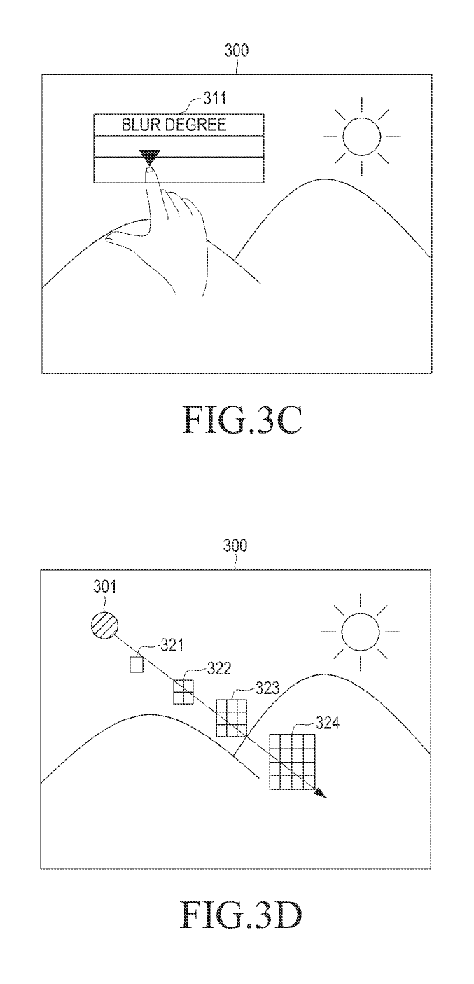

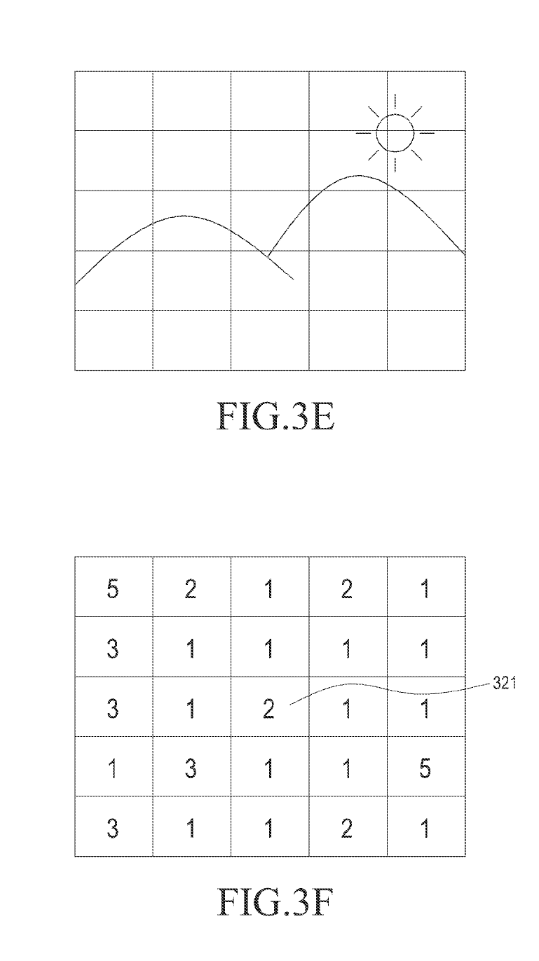

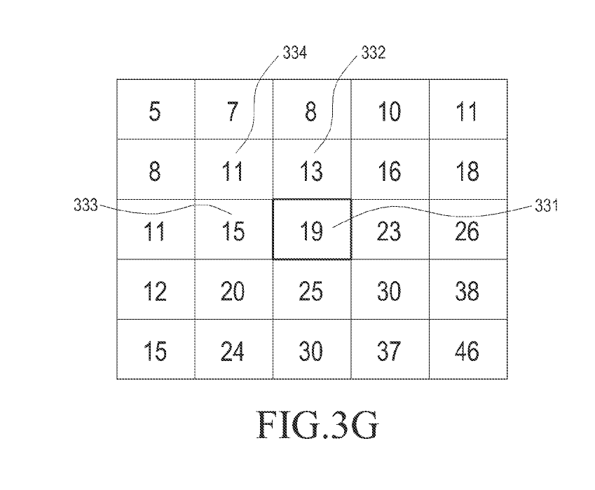

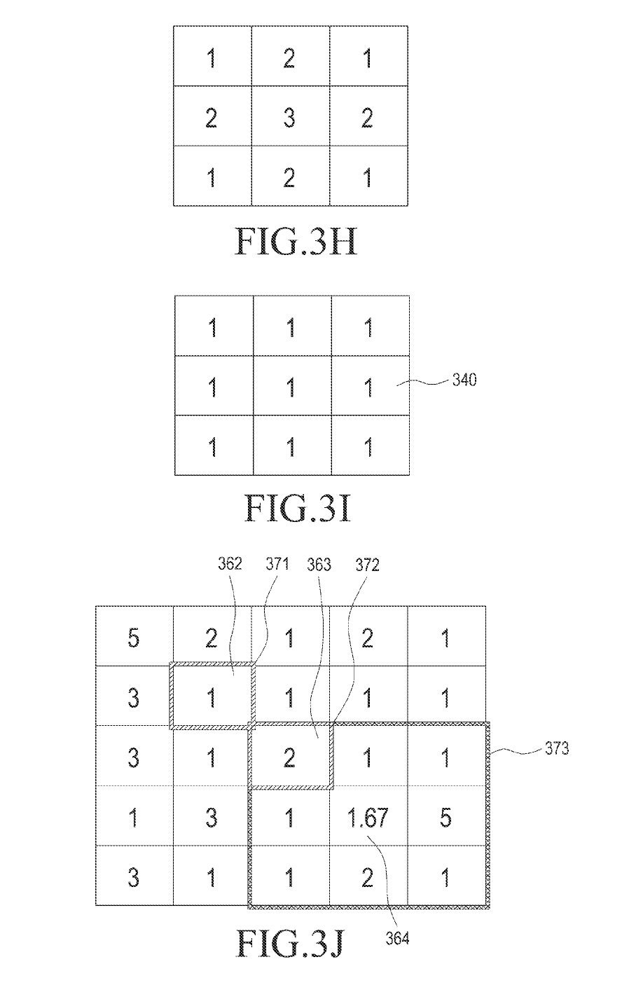

FIGS. 3A to 3J are conceptual diagrams for describing a blurred image generating process according to an embodiment of the present invention.

FIG. 3A illustrates a target image 300 according to an embodiment of the present invention, and FIG. 3B is a conceptual diagram for describing an input of the blur effect information on the target image 300 according to an embodiment of the present invention. As illustrated in FIG. 3B, the user inputs a drag motion from a first point 301 to a second point 302 of the target image. Here, an input of the drag motion from a particular start point to a particular end point is recognized as a command instructing the generation of a blur effect of which the degree gradually increases from the start point to the end point. Alternatively, the drag motion may be recognized as a command instructing the generation of a blur effect of which the degree increases from the particular start point to the particular end point, that is, the first point 301 to the second point 302. That is, the blur effect may be generated in an outer part of the second point 302.

Meanwhile, in FIG. 3C, the user determines the blur effect degree by designating it through a blur effect degree input window 311 additionally generated in the target image 300. The blur effect degree input window 311 includes an indicator which indicates the blur effect degree, and the user may determine the blur effect degree through an input of the drag motion after designating the indicator, for example, by touching the indicator. When the user inputs the blur effect degree by designating the indicator, the blurred image providing apparatus provides an image to which the blur effect is applied in real time.

FIG. 3D illustrates a process of applying mean filters having various sizes according to an embodiment of the present invention. As illustrated in FIG. 3B, the blur effect information is information for allowing the blur effect degree to gradually increase from the first point 301 to the second point 302. Accordingly, the blurred image providing apparatus configures the blurred image where the blur effect degree gradually increases from the first point 301 to the second point 302. As described above, when a relatively large sized mean filter is applied, the relatively large blur effect is created. Accordingly, the blurred image providing apparatus may apply mean filters 321, 322, 323, and 324 having sizes which gradually increase as they become further away from the first point 301. As the mean filters having gradually increasing sizes are applied, the blur image where the blur effect degree gradually increases from the first point 301 to the second point 302 is generated.

FIG. 3E is a conceptual diagram illustrating the target image from a viewpoint of a pixel. In this embodiment, it is assumed that the target image 300 has a pixel size of 5×5.

FIG. 3F is a conceptual diagram illustrating a pixel value of the target image 300. For example, a (3,3) pixel value of the target image 300 is 2, and other pixels also have pixel values, respectively.

FIG. 3G is the sum image of FIG. 3 according to an embodiment of the present invention. Each pixel of the sum image has a pixel value. For example, a (3,3) pixel value may be 19. Each pixel value of FIG. 3G may be determined by Equation (1). Meanwhile, in another embodiment, a (2,3) pixel value 333, a (3,2) pixel value 332, and a (2,2) pixel value 334 may be used to determine a (3,3) pixel value 331. More specifically, the blurred image providing apparatus determines the (3,3) pixel value 331 as a value generated by subtracting the (2,2) pixel value 334 from a sum of the (3,2) pixel value 332 and the (2,3) pixel value 333. That is, the blurred image providing apparatus determines the (i,j) pixel value based on Equation (5) below.

s(i,j)=s(i−1,j)+s(i,j−1)−s(i−1,j−1) (5)

As described above, the blurred image providing apparatus may form a sum image as illustrated in FIG. 3G in various ways.

FIG. 3H is an example of the Gaussian filter, and FIG. 3I is an example of the mean filter. The Gaussian filter has a relatively high value in the center and relatively lower values as you proceed to the edge. In contrast, the mean filter of FIG. 3I may have the same value in all pixels, for example, a value 340 of 1.

FIG. 3J is a conceptual diagram for describing an application result of mean filters having various sizes according to an embodiment of the present invention.

As illustrated in FIG. 3J, a mean filter 371 having a relatively small size, for example, a 1×1 size, is applied to a (2,2) pixel 362 corresponding to the first point 301 of FIG. 3B. Further, a mean filter 372 having a 1×1 size is applied to a (3,3) pixel 363 relatively adjacent to the first point 301. Meanwhile, a mean filter 373 having a 3×3 size is applied to a (4,4) pixel 364 corresponding to the second point 302. The mean filter 373 having the 3×3 size is applied to (3,3), (3,4), (3,5), (4,3), (4,4), (4,5), (5,3), (5,4), and (5,5) pixels. A value after the mean filter is applied to the (4,4) pixel 364 is determined as 1.67. The pixel value 1.67 is determined by Equation (4). In order to apply Equation (4) to the (3,3), (3,4), (3,5), (4,3), (4,4), (4,5), (5,3), (5,4), and (5,5) pixels, values of the sum image corresponding to the (2,2) pixel, the (2,5) pixel, the (5,2) pixel, and (5,5) pixel are used. An application result of the embodiment of Equation (4) is presented below as Equation (6).

$$\frac{46 + 19 - 24 - 26}{{3}^{2}} = 1.67 \qquad ( 6 )$$

As described above, according to the use of the sum image, a sum calculation of the pixel values within the mean filter is not required, thereby significantly reducing calculation quantities.

According to the above description, the blurred image providing apparatus generates the image to which the mean filter is applied while reducing the calculation quantities, and provides the blurred image.

FIG. 4 is a block diagram of a blurred image providing apparatus according to another embodiment of the present invention.

As illustrated in FIG. 4, a blurred image providing apparatus 400 includes an input unit 410, a photographing unit 420, a storage unit 430, a controller 440, and a display unit 450.

The input unit 410 receives blur effect information containing information on a blur effect. The input unit 410 may be implemented in the form of a key pad including a direction selection key or a determination key through which a user designates an area to which the blur effect is given or designates the blur effect degree. The user inputs the blur effect while visually recognizing the blur target image displayed on the display unit 450.

Alternatively, the input unit 410 may be physically connected to the display unit 450 to be implemented in the form of a touch screen. In the case where the input unit 410 is implemented by the touch screen, when the user inputs blur effect information, the user may directly designate a particular area on the target image. More specifically, the user designates an area to which the blur effect is given, by using a finger, an Electromagnetic resonance (EMR) pen, or the like.

The input unit 410 outputs blur effect information to the controller 440.

The photographing unit 420 photographs a target image. The photographing unit 420 photographs a target to be photographed and outputs the target image under the control of the controller. The photographing unit 420 may be implemented in a form of a camera module or the like, and the camera module may be based on a CMOS or CCD photographing element.

The storage unit 430 stores various programs, applications, an algorithm or the like required for a general operation of the blurred image providing apparatus 400. Further, the storage unit 430 stores an image taken by the photographing unit 420 or an image input by an external device. The storage unit 430 outputs an image selected by the controller 440 to the controller 440. The storage unit 430 may be a Non-Volatile Memory (NVM) such as a Solid State Disk (SSD), a flash memory card, a Read Only Memory (ROM) or the like, or a volatile memory such as a Random Access Memory (RAM) or the like.

An input signal analyzer 441 analyzes blur effect information input from the input unit 410. The input signal analyzer 441 applies the input blur effect information to the target image input from the photographing unit 420 or the storage unit 430. For example, the input signal analyzer 441 may determine pixels to which the blur effect is to be applied among the pixels of the target image. Further, the input signal analyzer 441 may apply mean filters having various sizes to the respective pixels to which the blur effect is to be applied, based on a blur effect degree. For example, a relatively large sized mean filter may be applied to the pixel to which a large blur effect degree is to be applied, and a relative small sized mean filter may be applied to the pixel to which a small blur effect degree is to be applied.

A sum image generator 442 generates a sum image for the target image. Since the sum image generating process has been described in detail in association with Equation (1) or Equation (5), the sum image generating process will be omitted to avoid redundancy. The sum image generator 442 generates the sum image according to various embodiments by Equation (1) or Equation (5) in various ways.

Meanwhile, the blurred image providing apparatus 400 based on an embodiment of FIG. 4 may apply a Gaussian filter to an edge part of the target image, for example, to pixels in an outer edge. As described above, the mean filter is applied to the user designated part, and the Gaussian filter is applied to the outer edge, so that a more natural blur effect can be created.

A filter type selector 443 distinguishes between the pixel to which the mean filter is to be applied and the pixel in the outer edge to which the Gaussian filter is to be applied, which are determined by the input signal analyzer 441.

A Gaussian filter applier 444 applies, for example, the Gaussian filter having a preset size as illustrated in FIG. 3H to the Gaussian filter application pixel determined by the filter type selector 443.

A mean filter applier 445 applies mean filters having various sizes to the target image based on the blur effect degree.

A blurred image generator 446 generates a blurred image based on pixel values to which the Gaussian filter and the mean filter are applied by the Gaussian filter applier 444 and the mean filter applier 445.

The display unit 450 displays the target image. The user inputs blur effect information based on a display result of the display unit 450. Further, the display unit 450 displays the blurred image generated by the blurred image generator 446. According to the above described process, based on the reduction of calculation quantities, the user identifies in real time the blurred image to which the blur effect information input by the user is reflected. The display unit 450 may be implemented by a display means such as an LCD module or the like. Also, the display unit 450 may be implemented in a form of a touch screen physically connected to the input unit 410. Meanwhile, it may be understood by those skilled in the art that the display unit 450 may be any means which can display a predetermined image.

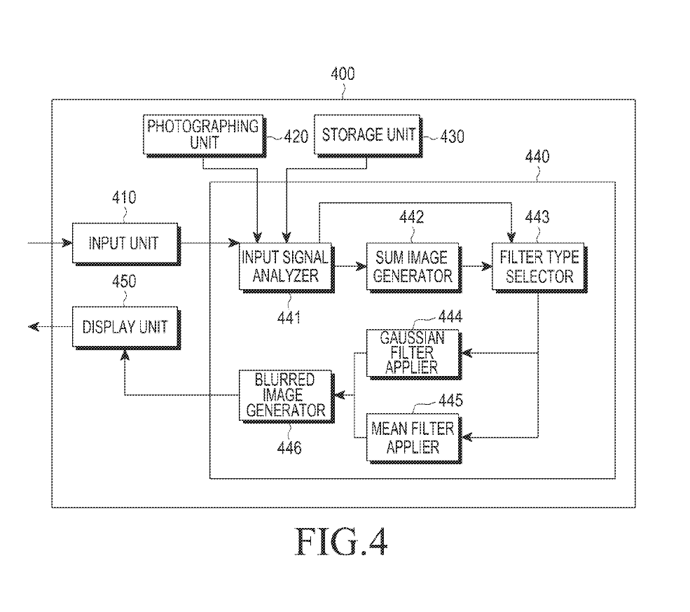

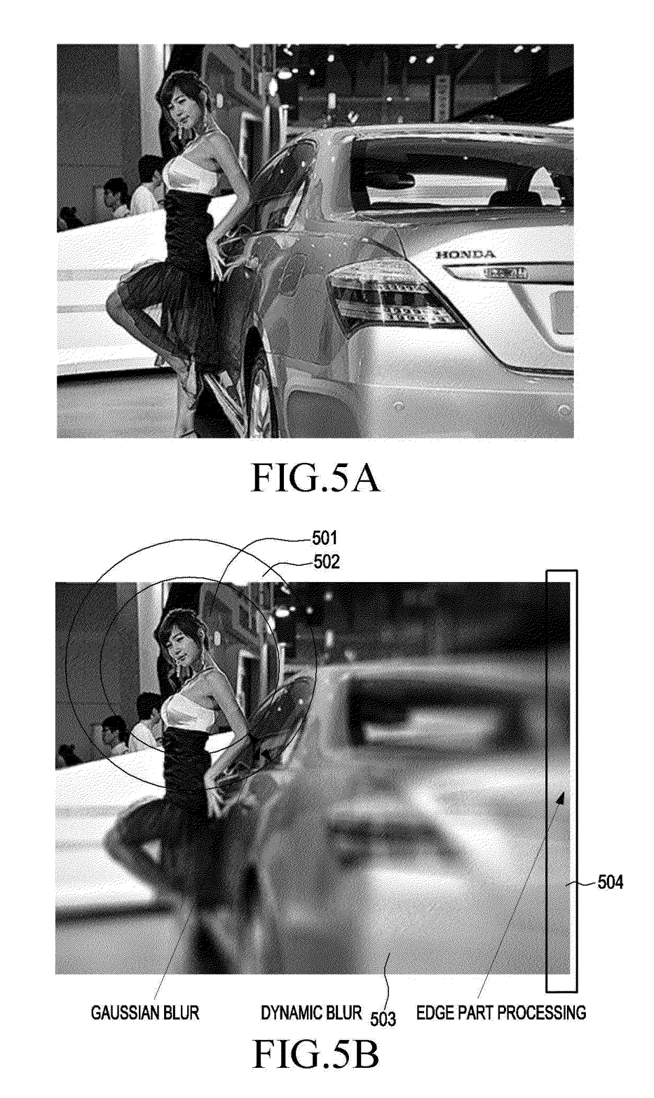

FIG. 5A is an illustrative diagram of a target image according to an embodiment of the present invention. FIG. 5B is an illustrative diagram of a blurred image generated by applying the blur effect to the target image of the FIG. 5A. In this embodiment, it is assumed that blur effect information input into the diagram of FIG. 5A by the user gradually increases the blur effect 503 from a blur effect start point 501 to an end point 502. The blurred image providing apparatus applies a higher size mean filter farther away from the blur effect start point 501. Further, the blurred image providing apparatus applies the Gaussian filter to an edge part 504.

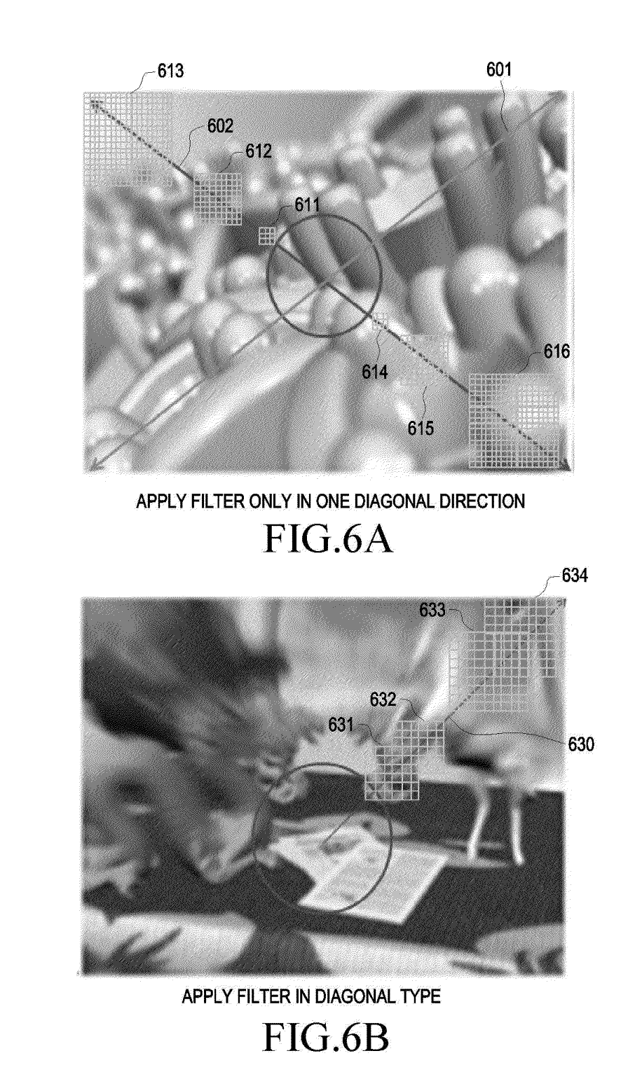

FIGS. 6A and 6B are conceptual diagrams for describing examples of blur effect information according to various embodiments of the present invention. The blur effect information of FIG. 6A applies the blur effect only in one direction from the blur effect start point 611. That is, the blur effect information may not apply the blur effect in a diagonal direction 601, but the blur effect information applies a gradually increasing blur effect degree in the other diagonal direction 602. Here, the blur effect information may be a motion of touching the start point 611 and then dragging in the blur effect application direction 602 while maintaining the touch by the user. In another embodiment, the blur effect information may be a motion of multi-touching two points in the blur effect start point 611 and then dragging in both directions of the diagonal line 602 by the user. That is, the blur effect information may be a stretching motion in both directions of the diagonal line 602 from the blur effect start point 611. The blurred image providing apparatus may apply mean filters 611, 612, 613, 614, 615, and 616 of which the sizes gradually increase.

The blur effect information of FIG. 6B may apply a gradually increasing blur effect degree in all directions from the blur effect start point. For example, the blur effect may be a drag motion in one direction 630 from the start point. Accordingly, the blurred image providing apparatus may apply mean filters 631, 632, 633, and 634 of which the sizes gradually increase.

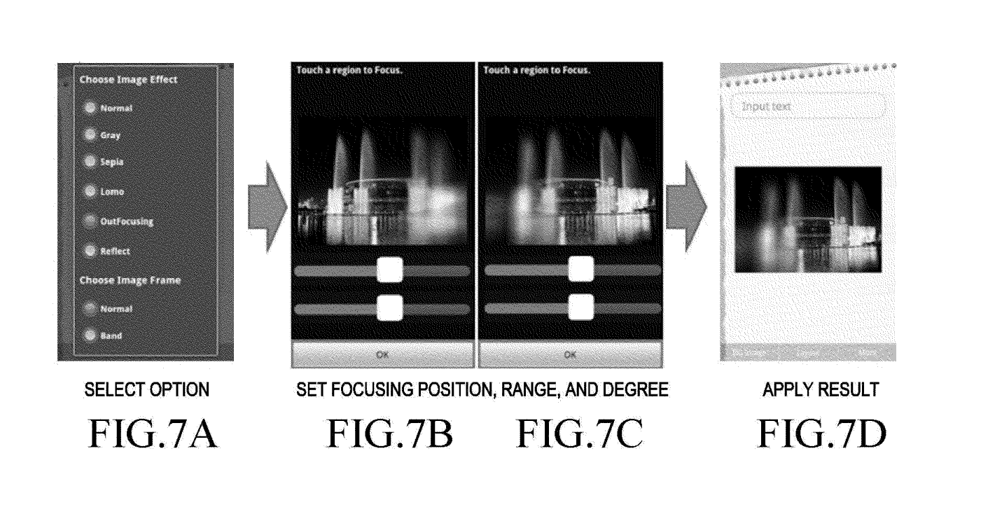

FIGS. 7A to 7D are conceptual diagrams of a user interface according to the present invention. The user interface of FIGS. 7A to 7D may be implemented, for example, in a form of being displayed on a touch screen where the input unit 110 and the display unit 130 of FIG. 1 are connected.

FIG. 7A is an illustrative diagram of a menu window to which blur effect information is input. In FIG. 7A, the user starts inputting the blur effect information by tapping (outoffocusing) for inputting the blur effect.

In FIG. 7B, the user inputs a point to which the blur effect is to be applied and a blur effect degree. Further, as illustrated in FIG. 7C, the user identifies in real time the image to which the blur effect is applied in response to the blur effect information input.

In FIG. 7D, the blurred image providing apparatus provides the final blurred image.

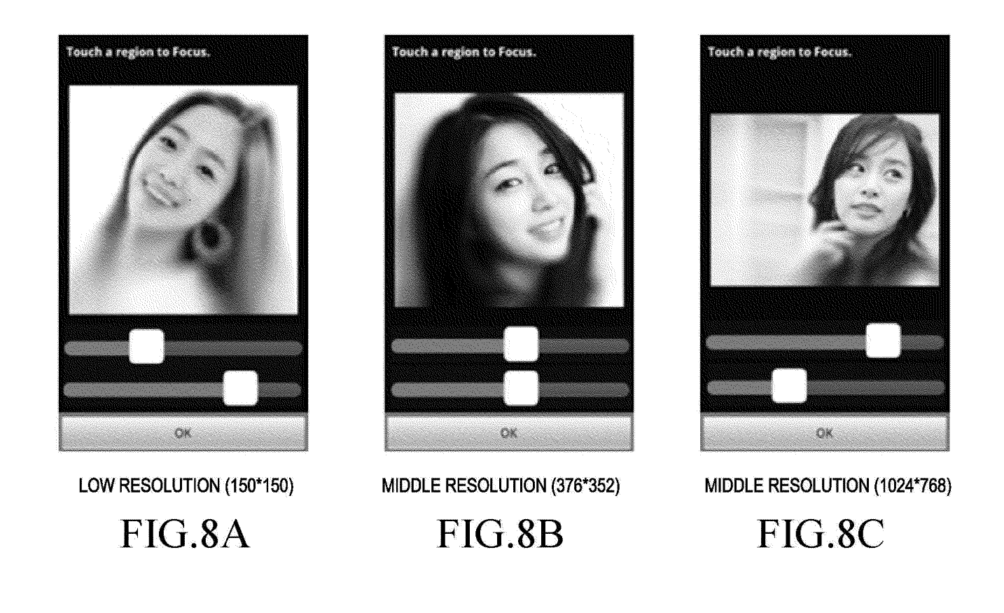

FIGS. 8A to 8C are illustrative diagrams of blurred images based on various resolutions according to various embodiments of the present invention. As illustrated in FIGS. 8A to 8C, the blurred image providing apparatus is applied, for example, to all of a low resolution of 150×150 pixel, a middle resolution of 376×352 pixel, and a high resolution of 1024×768 pixel. Particularly, the blurred image generates the high resolution of 1024×768 pixels without the burdens of the calculations.

While the present invention has been shown and described with reference to certain embodiments thereof, it will be understood by those skilled in the art that various changes in form and details may be made therein without departing from the spirit and scope of the present invention as defined by the appended claims. Therefore, various modified implementations can be made without departing from the substance of the present invention claimed in the appended claims, and the modified implementations should not be construed separately from the technical idea or prospect of the present invention.

What is claimed is:

1. A method of providing a blurred image, comprising:
receiving a target image to which a blur effect is to be applied;
receiving blur effect information for generating the blur effect in the target image;
calculating a sum image for respective pixels of the target image;
applying a mean filter to the target image by using the sum image based on the blur effect information; and
providing a blurred image formed by applying the mean filter.

2. The method of claim 1, wherein the blur effect information contains a designated blur effect start point.

3. The method of claim 2, wherein the blur effect information further contains a blur effect area and a blur effect degree.

4. The method of claim 1, wherein applying the mean filter comprises:
determining a pixel to which the blur effect is to be applied;
determining a size of the mean filter to be applied to the pixel to which the blur effect is to be applied;
determining a sum within the mean filter having the determined size based on the sum image; and
applying the mean filter based on the sum within the mean filter.

5. The method of claim 4, wherein an application result of the mean filter is determined by
$${f}^{′} ( i , j ) = \frac{s ( i , j ) + s ( i - p , j - p ) - s ( i - p , j ) - s ( i , j - p )}{{p}^{2}} ,$$
where f(i,j) denotes a result value to which the mean filter is applied in an (i,j) pixel, s(i,j) denotes an (i,j) pixel value of the sum image, and the size of the mean filter is p×p.

6. The method of claim 1, wherein applying the mean filter comprises applying a relatively large sized mean filter when a blur effect degree contained in the blur effect information is relatively large and applying a relatively small sized mean filter when the blur effect degree contained in the blur effect information is relatively small.

7. The method of claim 1, wherein calculating the sum image comprises determining a value of each pixel of the sum image based on S(i,j)=S(i−1,j)+s(i,j−1)−s(i−1,j−1), where s(i,j) denotes an (i,j) pixel value of the sum image.

8. The method of claim 1, wherein the blur effect information corresponds to a drag motion input from a first point of the target image to a second point of the target image, and
wherein applying the mean filter comprises applying a mean filter of which a size gradually increases from the first point to the second point to pixels adjacent to each of the first point and the second point.

9. The method of claim 1, wherein the blur effect information corresponds to a stretching motion input in a first direction and a second direction from a first point of the target image, and
wherein applying the mean filter comprises applying a mean filter of which a size gradually increases in the first direction and the second direction from the first point to pixels adjacent each of the first direction and the second direction from the first point.

10. The method of claim 1, further comprising applying a Gaussian filter to a pixel located on an edge of the target image.

11. An apparatus for providing a blurred image, comprising:
an input unit for receiving blur effect information for generating a blur effect in a target image to which the blur effect is to be applied;
a controller for calculating a sum image for respective pixels of the target image, and applying a mean filter to the target image by using the sum image based on the blur effect information; and
a display unit for providing a blurred image formed by applying the mean filter.

12. The apparatus of claim 11, wherein the blur effect information contains a designated blur effect start point.

13. The apparatus of claim 12, wherein the blur effect information further contains a blur effect area and a blur effect degree.

14. The apparatus of claim 11, wherein the controller determines a pixel to which the blur effect is to be applied, determines a size of the mean filter to be applied to the pixel to which the blur effect is to be applied, determines a sum within the mean filter having the determined size based on the sum image, and applies the mean filter based on the sum within the mean filter.

15. The apparatus of claim 14, wherein an application result of the mean filter is determined by
$${f}^{′} ( i , j ) = \frac{s ( i , j ) + s ( i - p , j - p ) - s ( i - p , j ) - s ( i , j - p )}{{p}^{2}} ,$$
where f(i,j) denotes a result value to which the mean filter is applied in an (i,j) pixel, s(i,j) denotes an (i,j) pixel value of the sum image, and the size of the mean filter is p×p.

16. The apparatus of claim 11, wherein the controller applies a relatively large sized mean filter when a blur effect degree contained in the blur effect information is relatively large and applies a relatively small sized mean filter when the blur effect degree contained in the blur effect information is relatively small.

17. The apparatus of claim 11, wherein the controller determines a value of each pixel of the sum image based on S(i,j)=S(i−1,j)+s(i,j−1)−s(i−1,j−1), where s(i,j) denotes an (i,j) pixel value of the sum image.

18. The apparatus of claim 11, wherein the blur effect information corresponds to a drag motion input from a first point of the target image to a second point of the target image, and
wherein the controller applies a mean filter of which a size gradually increases from the first point to the second point to pixels adjacent to each of the first point and the second point.

19. The apparatus of claim 11, wherein the blur effect information corresponds to a stretching motion input in a first direction and a second direction from a first point of the target image, and
wherein the controller applies a mean filter of which a size gradually increases in the first direction and the second direction from the first point to pixels adjacent each of the first direction and the second direction from the first point.

20. The apparatus of claim 11, wherein the controller applies a Gaussian filter to a pixel located on an edge of the target image.
